(19) United States
(12) Patent Application Publication
(10) Pub. No.: US 2022/0292371 A1
(43) Pub. Date: Sep. 15, 2022

(54) INFORMATION PROCESSING METHOD, INFORMATION PROCESSING SYSTEM, AND INFORMATION PROCESSING DEVICE

(71) Applicant: Panasonic Intellectual Property Corporation of America, Torrance, CA (US)

(72) Inventors: Yasunori ISHII, Osaka (JP); Yohei NAKATA, Osaka (JP); Tomoyuki OKUNO, Osaka (JP)

(21) Appl. No.: 17/828,615

(22) Filed: May 31, 2022

Related U.S. Application Data
(63) Continuation of application No. PCT/JP2020/042082, filed on Nov. 11, 2020.
(60) Provisional application No. 62/944,668, filed on Dec. 6, 2019.

(30) Foreign Application Priority Data
Jun. 9, 2020 (JP) 2020-099961

(51) Int. Cl. G06N 5/02

(52) U.S. Cl. CPC G06N 5/022

(57) ABSTRACT

An information processing method includes: obtaining first data; calculating a first prediction result by inputting the first data into a first prediction model; calculating a second prediction result by inputting the first data into a second prediction model; calculating a degree of similarity between the first prediction result and the second prediction result; determining second data which is training data for machine learning, based on the degree of similarity; and training the second prediction model by machine learning using the second data.

### CROSS REFERENCE TO RELATED APPLICATIONS

This is a continuation application of PCT International Application No. PCT/JP2020/042082 filed on Nov. 11, 2020, designating the United States of America, which is based on and claims priority of U.S. Provisional Patent Application No. 62/944,668 filed on Dec. 6, 2019 and Japanese Patent Application No. 2020-099961 filed on Jun. 9, 2020. The entire disclosures of the above-identified applications, including the specifications, drawings and claims are incorporated herein by reference in their entirety.

### FIELD

The present disclosure relates to an information processing method, an information processing system, and an information processing device for training a prediction model by machine learning.

### BACKGROUND

In recent years, conversion of a prediction model into a lighter prediction model is being carried out in order to make processing lighter during execution of deep learning on an edge device. For example, Patent Literature (PTL) 1 discloses a technique of converting a prediction model while keeping prediction performance as is before and after prediction model conversion. In PTL 1, conversion of a prediction model (for example, conversion from a first prediction model to a second prediction model) is carried out in such a way that prediction performance does not drop.

### CITATION LIST

### Patent Literature

PTL 1: United States Unexamined Patent Application Publication No.

### SUMMARY

### Technical Problem

However, in the technique disclosed in above-described PTL 1, even if the prediction performance (for example, recognizing performance such as recognition rate) is the same between the first prediction model and the second prediction model, there are cases where the behavior (for example, correct answer/incorrect answer) of the first prediction model and the behavior of the second prediction model are different for a certain prediction target. Specifically, between the first prediction model and the second prediction model, there are cases where, even when statistical prediction results are the same, individual prediction results are different.

In view of this, the present disclosure provides an information processing method, and the like, that can bring the behavior of a first prediction model and the behavior of a second prediction model closer together.

### Solution to Problem

An information processing method according to the present disclosure is a method to be executed by a computer, and includes: obtaining first data; calculating a first prediction result by inputting the first data into a first prediction model; calculating a second prediction result by inputting the first data into a second prediction model; calculating a degree of similarity between the first prediction result and the second prediction result; determining second data which is training data for machine learning, based on the degree of similarity; and training the second prediction model by machine learning using the second data, wherein either: the degree of similarity is whether or not the first prediction result and the second prediction result match, and in the determining, when the first prediction result and the second prediction result do not match, data generated by processing the first data which has been inputted to the first prediction model and the second prediction model is determined as the second data; or the degree of similarity is a degree of similarity between a magnitude of a first prediction value in the first prediction result and a magnitude of a second prediction value in the second prediction result, and in the determining, when a difference between the first prediction value and the second prediction value greater than or equal to a threshold value, the data generated by processing the first data which has been inputted to the first prediction model and the second prediction model is determined as the second data.

It should be noted that these generic or specific aspects may be implemented as a system, a method, an integrated circuit, a computer program, or a computer-readable recording medium such as a CD-ROM, or may be implemented as any combination of a system, a method, an integrated circuit, a computer program, and a recording medium.

### Advantageous Effects

An information processing method, and the like, according to an aspect of the present disclosure can bring the behavior of a first prediction model and the behavior of a second prediction model closer together.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram illustrating an example of an information processing system according to an embodiment.

FIG. 2 is a flowchart illustrating an example of an information processing method according to the embodiment.

FIG. 3A is a diagram illustrating an example of a feature value space stretched by the output of a layer before an identification layer in a first prediction model and a feature value space stretched by the output of a layer before an identification layer in a second prediction model.

FIG. 3B is a diagram illustrating an example of first data at the time when the behavior of the first prediction model and the behavior of the second prediction model do not coincide.

FIG. 4 is a flowchart illustrating an example of a training method for a second prediction model according to the embodiment.

FIG. 5 is a block diagram illustrating an example of an information processing system according to a variation of the embodiment.

FIG. 6 is a block diagram illustrating an example of an information processing device according to another embodiment.

### DESCRIPTION OF EMBODIMENTS

In the related art, the conversion of the prediction model is carried out in such a way that prediction performance is not deteriorated. However, even if the prediction performance is the same between the first prediction model and the second prediction model, about a certain prediction target, there are cases where the behavior in the first prediction model and the behavior in the second prediction model are different. Here, behavior is an output of a prediction model with respect to each of a plurality of inputs. Specifically, even if statistical prediction results are the same in the first prediction model and the second prediction model, there are cases where individual prediction results are different. There is a risk that this difference causes a problem. For example, about a certain prediction target, there are cases where a prediction result is a correct answer in the first prediction model and a prediction result is an incorrect answer in the second prediction model and there are cases where a prediction result is an incorrect answer in the first prediction model and a prediction result is a correct answer in the second prediction model.

In this manner, if the behaviors are different between the first prediction model and the second prediction model, for example, even when the prediction performance of the first prediction model is improved and the second prediction model is generated from the first prediction model after the improvement, in some case, the prediction performance of the second prediction model is not improved or is deteriorated. For example, in the following processing in which a prediction result of a prediction model is used, there is also a risk that different processing results are output in the first prediction model and the second prediction model with respect to the same input. In particular, when the processing is processing relating to safety (for example, object recognition processing in a vehicle), there is a risk that the difference between the behaviors causes danger.

An information processing method according to an aspect of the present disclosure is a method to be executed by a computer, and includes: obtaining first data; calculating a first prediction result by inputting the first data into a first prediction model; calculating a second prediction result by inputting the first data into a second prediction model; calculating a degree of similarity between the first prediction result and the second prediction result; determining second data which is training data for machine learning, based on the degree of similarity; and training the second prediction model by machine learning using the second data.

Since the first prediction model and the second prediction model are different models, there are cases where, even when the same first data is inputted into each of them, the behavior of the first prediction model and the behavior of the second prediction model do not match. However, by using the degree of similarity between the first prediction result and the second prediction result that are obtained when the behavior of the first prediction model and the behavior of the second prediction model do not match, it is possible to determine the first data which results in the behavior of the first prediction model and the behavior of the second prediction model not matching. Then, it is possible to determine, from the first data, second data which is training data for training the second prediction model by machine learning so that the behavior of the second prediction model is brought closer to the behavior of the first prediction model. Therefore, the present disclosure can bring the behavior of the first prediction model and the behavior of the second prediction model closer together.

Furthermore, the first prediction model may have a configuration different from a configuration of the second prediction model.

Accordingly, the respective behaviors of the first prediction model and the second prediction model which have mutually different configurations (for example, network configurations) can be brought closer together.

Furthermore, the first prediction model may have a processing accuracy different from a processing accuracy of the second prediction model.

Accordingly, the respective behaviors of the first prediction model and the second prediction model which have mutually different processing accuracies (for example, bit precisions) can be brought closer together.

Furthermore, the second prediction model may be obtained by making the first prediction model lighter.

Accordingly, the behavior of the first prediction model and the behavior of the second prediction model which has been made lighter can be brought closer together. Because the second prediction model is trained so that the behavior of the second prediction model which has been made lighter is brought closer to the behavior of the first prediction model, the performance of the second prediction model that has been made lighter can be brought closer to the performance of the first prediction model, and enhancement of the accuracy of the second prediction model also becomes possible.

Furthermore, the degree of similarity may include whether or not the first prediction result or the second prediction result match.

Accordingly, the first data which results in the behavior of the first prediction model and the behavior of the second prediction model not matching can be determined based on whether or not the first prediction result and the second prediction result match. Specifically, the first data when the first prediction result and the second prediction result do not match can be determined as the first data which results in the behavior of the first prediction model and the behavior of the second prediction model not matching.

Furthermore, in the determining, the second data may be determined based on the first data which is the input when the first prediction result and the second prediction result do not match.

Accordingly, the second prediction model can be trained based on the first data which results in the first prediction result and the second prediction result not matching. This is effective in prediction in which matching or not matching is clear.

Furthermore, the degree of similarity may include a degree of similarity between a magnitude of a first prediction value in the first prediction result and a magnitude of a second prediction value in the second prediction result.

Accordingly, first data which results in the behavior of the first prediction model and the behavior of the second prediction model not matching can be determined based on the degree of similarity between the magnitude of a prediction value in the first prediction result and the magnitude of a prediction value in the second prediction result. Specifically, the first data when the difference between the magnitude of a prediction value in the first prediction result and the magnitude of a prediction value in the second prediction result is big can be determined as the first data which results in the behaviors of the first prediction model and the second prediction model not matching.

Furthermore, in the determining, the second data may be determined based on the first data which is the input when the difference between the first prediction value and the second prediction value is greater than or equal to a threshold value.

Accordingly, the second prediction model can be trained based on the first data which results in the difference between the first prediction value and the second prediction value being greater than or equal to a threshold value. This is effective in prediction in which it is difficult to clearly judge between matching and not matching.

Furthermore, the second data may be data generated by processing the first data.

Accordingly, data generated by processing the first data which results in the behavior of the first prediction model and the behavior of the second prediction model not matching can be determined as the second data.

Furthermore, in the training, the second prediction model may be trained using more of the second data than other training data.

Accordingly, by using much of the second data which is effective as training data of the second prediction model, the machine learning of the second prediction model can be effectively advanced.

Furthermore, the first prediction model and the second prediction model may be neural network models.

Accordingly, the respective behaviors of the first prediction model and the second prediction model which are neural network models can be brought closer together.

An information processing system according to an aspect of the present disclosure includes: an obtainer that obtains first data; a prediction result calculator that calculates a first prediction result by inputting the first data into a first prediction model, and calculates a second prediction result by inputting the first data into a second prediction model; a similarity calculator that calculates a degree of similarity between the first prediction result and the second prediction result; a determiner that determines second data which is training data for machine learning, based on the degree of similarity; and a trainer that trains the second prediction model by machine learning using the second data.

Accordingly, it is possible to provide an information processing system that can bring the behavior of the first prediction model and the behavior of the second prediction model closer together.

An information processing device according to an aspect of the present disclosure includes: an obtainer that obtains sensing data; a controller that obtains a prediction result by inputting the sensing data into a second prediction model; and an outputter that outputs data based on the prediction result obtained. The second prediction model is trained by machine learning using second data. The second data is training data for machine learning and is determined based on a degree of similarity. The degree of similarity is calculated from a first prediction result and a second prediction result. The first prediction result is calculated by inputting first data into a first prediction model, and the second prediction result is calculated by inputting the first input data into the second prediction model.

Accordingly, the second prediction model whose behavior has been brought closer to the behavior of the first prediction model can be used in a device. With this, it is possible to improve the performance of prediction processing using a prediction model in an embedded environment.

Hereinafter, embodiments will be described in detail with reference to the Drawings.

It should be noted that each of the following embodiments shows a generic or specific example. The numerical values, shapes, materials, structural components, the arrangement and connection of the structural components, steps, the processing order of the steps, etc. shown in the following embodiments are mere examples, and thus are not intended to limit the present disclosure.

### Embodiment

An information processing system according to an embodiment is explained below.

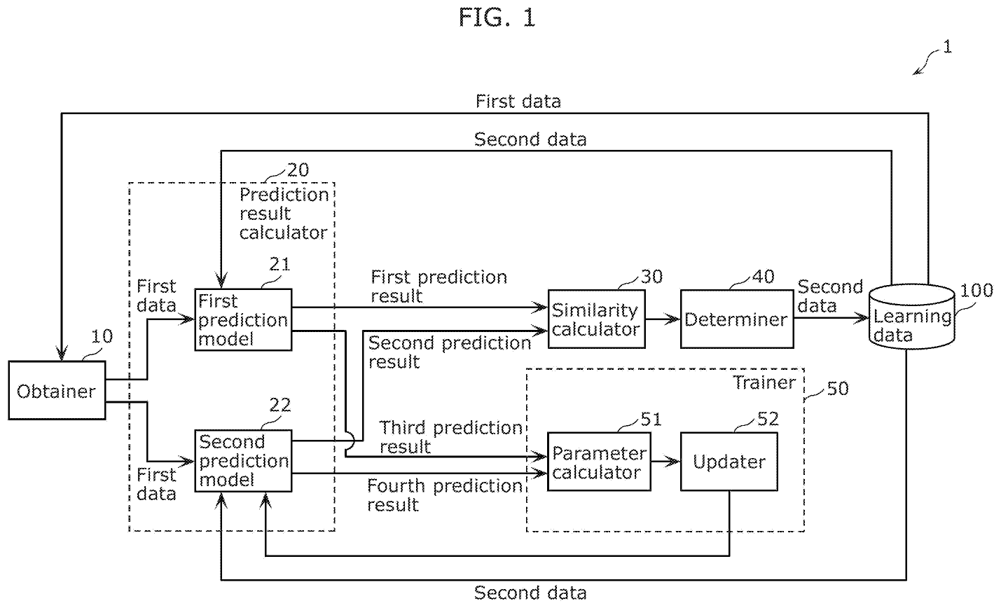

FIG. 1 is a block diagram illustrating an example of information processing system 1 according to the embodiment. Information processing system 1 includes obtainer 10, prediction result calculator 20, first prediction model 21, second prediction model 22, similarity calculator 30, determiner 40, trainer 50, and learning data 100.

Information processing system 1 is a system for training second prediction model 22 with machine learning and uses learning data 100 in the machine learning. Information processing system 1 is a computer including a processor and a memory. The memory is a ROM (Read Only Memory), a RAM (Random Access Memory), and the like and can store programs to be executed by the processor. Obtainer 10, prediction result calculator 20, similarity calculator 30, determiner 40, and trainer 50 are realized by the processor or the like that executes the programs stored in the memory.

For example, information processing system 1 may be a server. Components configuring information processing system 1 may be disposed to be distributed to a plurality of servers.

Many types of data are included in learning data 100. For example, when a model caused to recognize an image is trained by the machine learning, image data is included in learning data 100. Various types (for example, classes) of data are included in learning data 100. Not that an image may be a captured image or may be a generated image.

First prediction model 21 and second prediction model 22 are, for example, neural network models and perform prediction on input data. The prediction is, for example, classification here but may be object detection, segmentation, estimation of a distance from a camera to an object, or the like. Note that behavior may be a correct answer/an incorrect answer or a class when the prediction is the classification, may be a size or a positional relation of a detection frame instead of or together with the correct answer/the incorrect answer or the class when the prediction is the object detection, may be a class, a size, or a positional relation of a region when the prediction is the segmentation, and may be length of an estimated distance when the prediction is the distance estimation.

For example, a configuration of first prediction model 21 and a configuration of second prediction model 22 may be different, processing accuracy of first prediction model 21 and processing accuracy of second prediction model 22 may be different, and second prediction model 22 may be a prediction model obtained by lightening of first prediction model 21. For example, when the configuration of first prediction model 21 and the configuration of second prediction model 22 are different, second prediction model 22 has a smaller number of branches or a smaller number of nodes than first prediction model 21. For example, when the processing accuracy of first prediction model 21 and the processing accuracy of second prediction model 22 are different, second prediction model 22 has lower bit accuracy than first prediction model 21. Specifically, first prediction model 21 may be a floating point model and second prediction model 22 may be a fixed point model. Note that the configuration of first prediction model 21 and the configuration of second prediction model 22 may be different and the processing accuracy of first prediction model 21 and the processing accuracy of second prediction model 22 may be different.

Obtainer 10 obtains first data from learning data 100.

Prediction result calculator 20 inputs the first data obtained by obtainer 10 to first prediction model 21 and second prediction model 22 and calculates a first prediction result and a second prediction result. Prediction result calculator 20 selects second data from learning data 100, inputs the second data to first prediction model 21 and second prediction model 22, and calculates a third prediction result and a fourth prediction result.

Similarity calculator 30 calculates a degree of similarity between the first prediction result and the second prediction result.

Determiner 40 determines the second data, which is training data in the machine learning, based on the calculated degree of similarity.

Trainer 50 trains second prediction model 22 with the machine learning using the determined second data. For example, trainer 50 includes parameter calculator 51 and updater 52 as functional components. Details of parameter calculator 51 and updater 52 are explained below.

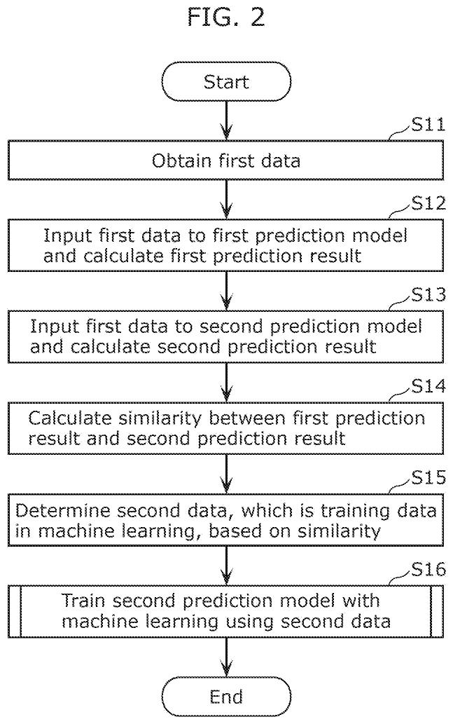

The operation of information processing system 1 is explained with reference to FIG. 2.

FIG. 2 is a flowchart illustrating an example of an information processing method according to the embodiment. The information processing method is a method executed by the computer (information processing system 1). Accordingly, FIG. 2 is also a flowchart illustrating an example of the operation of information processing system 1 according to the embodiment. Specifically, the following explanation is explanation of the operation of information processing system 1 and is explanation of the information processing method.

First, obtainer 10 obtains first data (step S11). For example, when the first data is an image, obtainer 10 obtains an image in which an object in a certain class is imaged.

Subsequently, prediction result calculator 20 inputs the first data to first prediction model 21 and calculates a first prediction result (step S12), inputs the first data to second prediction model 22 and calculates a second prediction result (step S13). Specifically, prediction result calculator 20 inputs the same first data to first prediction model 21 and second prediction model 22 to calculate the first prediction result and the second prediction result. Note that step S12 and step S13 may be executed in the order of step S13 and step S12 or may be executed in parallel.

Subsequently, similarity calculator 30 calculates a degree of similarity between the first prediction result and the second prediction result (step S14). The degree of similarity is a degree of similarity between the first prediction result and the second prediction result calculated when the same first data is input to first prediction model 21 and second prediction model 22 different from each other. Details of the degree of similarity are explained below.

Subsequently, determiner 40 determines second data, which is training data in the machine learning, based on the calculated degree of similarity (step S15). For example, the second data may be the first data itself or may be data obtained by processing the first data. For example, determiner 40 adds the determined second data to learning data 100. Note that determiner 40 may repeatedly add the second data to learning data 100. Each of the second data repeatedly added to learning data 100 may be the second data applied with different processing every time the second data is added.

Note that the processing of step S11 to step S15 being performed about one first data, the processing of step S11 to step S15 being performed about another first data next, and the like may be repeated to determine a plurality of second data. The processing of step S11 to step S15 may be collectively performed about a plurality of first data to determine a plurality of second data.

Trainer 50 trains second prediction model 22 with the machine learning using the determined second data (step S16). For example, trainer 50 trains second prediction model 22 using the second data more than other training data. For example, since a plurality of second data are added anew to learning data 100, the number of the second data in learning data 100 is large. Trainer 50 can train second prediction model 22 using the second data more than the other training data. For example, using the second data more than the other training data means that the number of the second data in the training is larger than the number of the other training data. For example, using the second data more than the other training data may mean that the number of times of use of the second data in the training is larger than the number of times of use of the other training data. Trainer 50 may receive, for example, from determiner 40, an instruction to train second prediction model 22 using the second data more than the other training data in learning data 100 and may train second prediction model 22 so that the number of times of training using the second data is larger than the number of times of training using the other training data. Details of the training of second prediction model 22 are explained below.

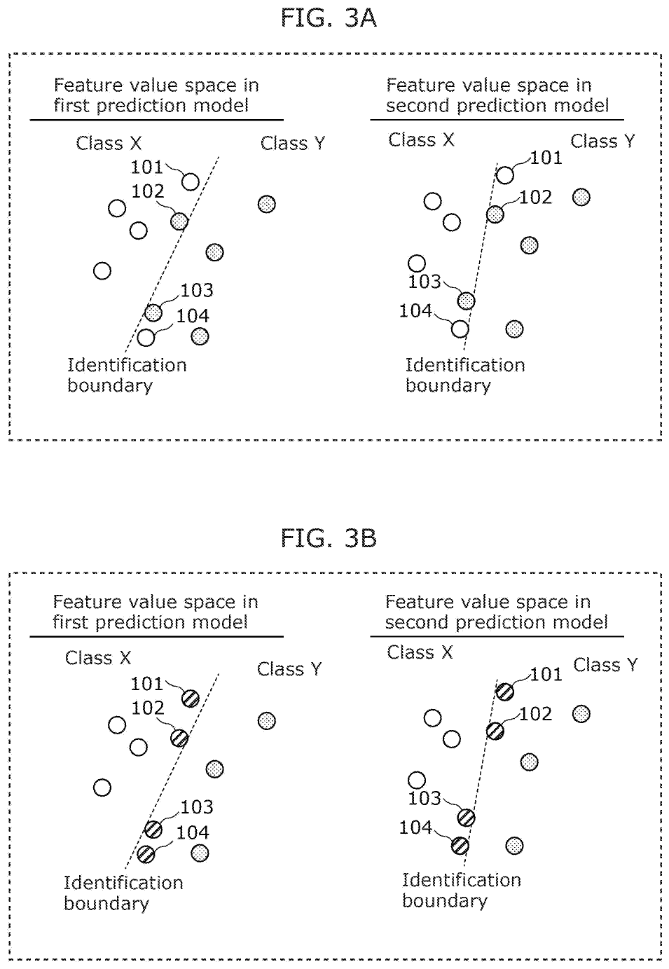

Here, a feature value space stretched by an output of a layer before an identification layer in first prediction model 21 and a feature value space stretched by an output of a layer before an identification layer in second prediction model 22 are explained with reference to FIG. 3A.

FIG. 3A is a diagram illustrating an example of the feature value space stretched by the output of the layer before the identification layer in first prediction model 21 and the feature value space stretched by the output of the layer before the identification layer in second prediction model 22. Note that the feature value space in second prediction model 22 illustrated in FIG. 3A is a feature value space in second prediction model 22 not trained by trainer 50 or halfway in the training by trainer 50. Ten circles in each of the feature value spaces indicate feature values of data input to each of the prediction models. Five white circles are respectively feature values of data of the same type (for example, class X). Five dotted circles are respectively feature values of data of the same type (for example, class Y). Class X and class Y are different classes. For example, about each of the prediction models, a prediction result of data, feature values of which are present further on the left side than an identification boundary in the feature value space, indicates class X and a prediction result of data, feature values of which are present further on the right side than the identification boundary, indicates class Y.

In FIG. 3A, feature values of first data 101, 102, 103, and 104, which are the first data, feature values of which are present near the identification boundary, are illustrated in each of the feature value space in first prediction model 21 and the feature value space in second prediction model 22. First data 101 is data of class X. When the same first data 101 is input to first prediction model 21 and second prediction model 22, a first prediction result indicates class X and a second prediction result indicates class Y. First data 102 is data of class Y. When the same first data 102 is input to first prediction model 21 and second prediction model 22, the first prediction result indicates class X and the second prediction result indicates class Y. First data 103 is data of class Y. When the same first data 103 is input to first prediction model 21 and second prediction model 22, the first prediction result indicates class Y and second prediction result indicates class X. First data 104 is data of class X. When the same first data 104 is input to first prediction model 21 and second prediction model 22, the first prediction result indicates class Y and the second prediction result indicates class X.

About the first prediction result and the second prediction result for first data 101 of class X, the first prediction result is in class X and is a correct answer but the second prediction result is in class Y and is an incorrect answer. About the first prediction result and the second prediction result for first data 102 of class Y, the second prediction result is in class Y and is a correct answer but the first prediction result is in class X and is an incorrect answer. About the first prediction result and the second prediction result for first data 103 of class Y, the first prediction result is in class Y and is a correct answer but the second prediction result is in class X and is an incorrect answer. About the first prediction result and the second prediction result for first data 104 of class X, the second prediction result is in class X and is a correct answer but the first prediction result is in class Y and is an incorrect answer. In this example, eight prediction results among ten prediction results are correct answers and have the same recognition rate of 80% in each of first prediction model 21 and second prediction model 22. About the same first data, prediction results of the first data, feature values of which are near the identification boundary, are different in first prediction model 21 and second prediction model 22. Behavior deviates in first prediction model 21 and second prediction model 22.

In contrast, in the present disclosure, a degree of similarity between the first prediction result and the second prediction result calculated when the same first data is input to first prediction model 21 and second prediction model 22 is focused. Data effective for matching behavior is intensively sampled from the second data, which is training data determined based on the degree of similarity. For example, the second data is determined based on a degree of similarity between the first prediction result and the second prediction result at the time when the behavior of first prediction model 21 and the behavior of second prediction model 22 do not coincide.

FIG. 3B is a diagram illustrating an example of the first data at the time when the behavior of first prediction model 21 and the behavior of second prediction model 22 do not coincide. Four circles in each of the feature value spaces are hatched. These circles indicate feature values of the first data input to first prediction model 21 and second prediction model 22 when the behavior of first prediction model 21 and the behavior of second prediction model 22 do not coincide. For example, a degree of similarity indicates whether the first prediction result and the second prediction result coincide. For example, a class (class X) indicated by the first prediction result and a class (class Y) indicated by the second prediction result for first data 101 do not coincide. A class (class X) indicated by the first prediction result and a class (class Y) indicated by the second prediction result for first data 102 do not coincide. A class (class Y) indicated by the first prediction result and a class (class X) indicated by the second prediction result for first data 103 do not coincide. A class (class Y) indicated by the first prediction result and a class (class X) indicated by the second prediction result for first data 104 do not coincide.

In this way, based on the degree of similarity between the first prediction result and the second prediction result (whether the first prediction result and the second prediction result coincide), specifically, based on the first data, which is the input in the case in which the first prediction result and the second prediction result do not coincide, determiner 40 determines, as the second data, the first data in which the behavior of first prediction model 21 and the behavior of second prediction model 22 do not coincide (in the example illustrated in FIG. 3A and FIG. 3B, first data 101, 102, 103, and 104). This is because improvement of a prediction model can be achieved by training the prediction model using, as training data, the first data in which a prediction result changes according to an input prediction model. Note that, even in the case of the first data in which the first prediction result and the second prediction result coincide, when a feature value is near the identification boundary, determiner 40 may determine the first data as the second data. This is because the first data, the feature value of which is near the identification boundary, is data in which the behavior of first prediction model 21 and the behavior of second prediction model 22 are highly likely to not coincide when the first data is input and is data effective to be used as the training data.

Note that the degree of similarity may include a degree of similarity between the magnitude of a first prediction value in the first prediction result and the magnitude of a second prediction value in the second prediction result. For example, when the difference between the magnitude of the first prediction value in the first prediction result for the first data and the magnitude of the second prediction value in the second prediction result for the first data is large, determiner 40 may determine the first data as the second data. Specifically, determiner 40 may determine the second data based on the first data, which is an input in the case in which the difference between the first prediction value and the second prediction value is equal to or larger than a threshold. This is because the first data in which the difference between the magnitude of the first prediction value in the first prediction result and the magnitude of the second prediction value in the second prediction result is large is data that reduces reliability, likelihood, or the like of prediction of a prediction model, that is, data in which it is highly likely that the behavior of first prediction model 21 and the behavior of second prediction model 22 do not coincide when the first data is input and is data effective to be used as the training data.

Note that determiner 40 may directly determine the first data as the second data and add the second data to learning data 100. However, determiner 40 may determine data obtained by processing the first data as the second data and add the second data to learning data 100. For example, the second data obtained by processing the first data may be data obtained by applying geometric transformation to the first data, may be data obtained by imparting noise to a value of the first data, or may be data obtained by applying linear transformation to the value of the first data.

Subsequently, a training method for second prediction model 22 is explained.

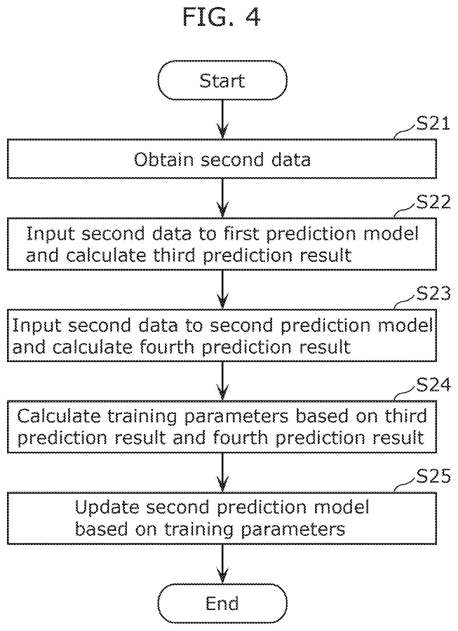

FIG. 4 is a flowchart illustrating an example of the training method for second prediction model 22 according to the embodiment.

Prediction result calculator 20 acquires the second data in order to perform intensive sampling using the second data (step S21).

Prediction result calculator 20 inputs the second data to first prediction model 21 and calculates the third prediction result (step S22) and inputs the second data to second prediction model 22 and calculates the fourth prediction result (step S23). Specifically, prediction result calculator 20 inputs the same second data to first prediction model 21 and second prediction model 22 to calculate the third prediction result and the fourth prediction result. Note that step S22 and step S23 may be executed in the order of step S23 and step S22 or may be executed in parallel.

Subsequently, parameter calculator 51 calculates training parameters based on the third prediction result and the fourth prediction result (step S24). For example, parameter calculator 51 calculates the training parameters such that an error between the third prediction result and the fourth prediction result decreases. The error decreasing means that the third prediction result and the fourth prediction result obtained when the same second data is input to first prediction model 21 and second prediction model 22 different from each other are prediction results close to each other. The error is smaller as the distance between the third prediction result and the fourth prediction result is smaller. The distance between prediction results can be calculated by, for example, cross-entropy.

Updater 52 updates second prediction model 22 using the calculated training parameters (step S25).

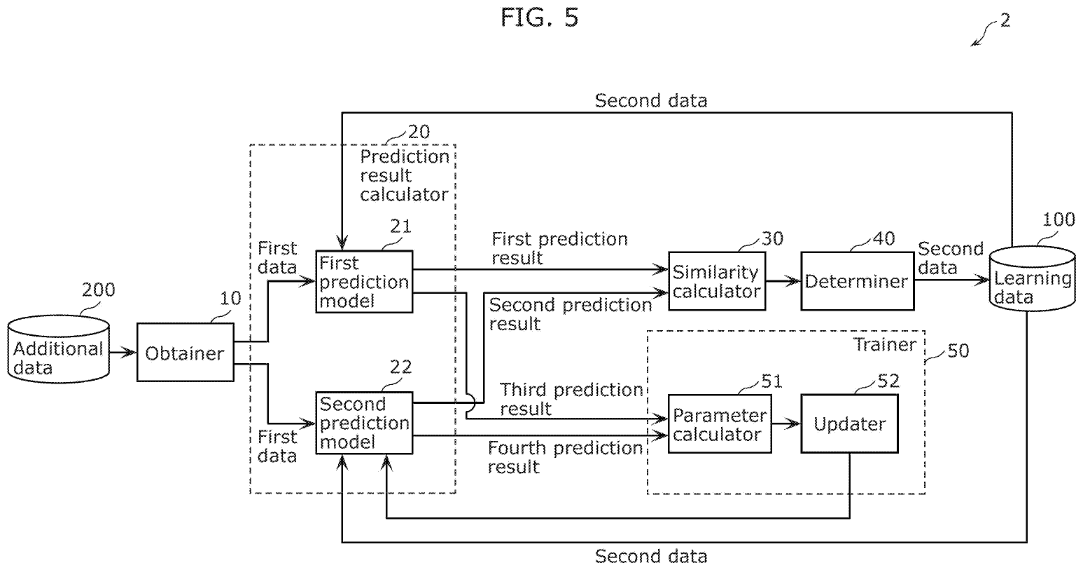

Note that an example is explained above in which obtainer 10 obtains the first data from learning data 100. However, obtainer 10 needs not to obtain the first data from learning data 100. This is explained with reference to FIG. 5.

FIG. 5 is a block diagram illustrating an example of information processing system 2 according to a variation of the embodiment.

Information processing system 2 according to the variation of the embodiment is different from information processing system 1 according to the embodiment in that information processing system 2 includes additional data 200 and obtainer 10 obtains the first data not from learning data 100 but from additional data 200. Otherwise, information processing system 2 is the same as information processing system 1 in the embodiment. Therefore, explanation of information processing system 2 is omitted.

As illustrated in FIG. 5, additional data 200 including the first data for determining the second data added to learning data 100 may be prepared separately from learning data 100. Specifically, not data originally included in learning data 100 but data included in additional data 200 prepared separately from learning data 100 may be used for the determination of the second data.

As explained above, first prediction model 21 and second prediction model 22 are the different models. Therefore, even if the same first data is input to first prediction model 21 and second prediction model 22, the behavior of first prediction model 21 and the behavior of second prediction model 22 sometimes do not coincide. However, by using a degree of similarity between the first prediction result and the second prediction result at the time when the behavior of first prediction model 21 and the behavior of second prediction model 22 do not coincide, it is possible to determine the first data in which the behavior of first prediction model 21 and the behavior of second prediction model 22 do not coincide. It is possible to determine, from the first data, the second data, which is training data for training second prediction model 22 with the machine learning to bring the behavior of second prediction model 22 close to the behavior of first prediction model 21. Therefore, according to the present disclosure, it is possible to bring the behavior of second prediction model 22 and the behavior of first prediction model 21 close to each other.

In normal intensive sampling learning, data near an identification boundary is intensively sampled about one prediction model. However, in the present disclosure, since data in which behavior coincide or does not coincide between prediction models is intensively learned, it is possible to stabilize learning.

When second prediction model 22 is a model obtained by lightening of first prediction model 21, second prediction model 22 is inferior to first prediction model 21 in accuracy. However, when the behavior of lightened second prediction model 22 comes close to the behavior of first prediction model 21, the performance of lightened second prediction model 22 can be brought close to the performance of first prediction model 21. It is also possible to improve the accuracy of second prediction model 22.

### OTHER EMBODIMENTS

The information processing method and information processing system 1 according to one or more aspects of the present disclosure are explained above based on the foregoing embodiments. However, the present disclosure is not limited to these embodiments. Various modifications applied to the embodiments that can be conceived by those skilled in the art as well as forms constructed by combining constituent elements in different embodiments, without departing from the essence of the present disclosure, may be included in the one or more aspects of the present disclosure.

For example, in the embodiment explained above, an example is explained in which second prediction model 22 is obtained by the lightening of first prediction model 21. However, second prediction model 22 needs not be a model obtained by the lightening of first prediction model 21.

For example, in the embodiment explained above, an example is explained in which the first data and the second data are the images. However, the first data and the second data may be other data. Specifically, the first data and the second data may be sensing data other than the images. For example, sensing data from which correct answer data is obtainable such as voice data output from a microphone, point group data output from a radar such as a LiDAR, pressure data output from a pressure sensor, temperature data or humidity data output from a temperature sensor or a humidity sensor, and smell data output from a smell sensor may be set as processing targets.

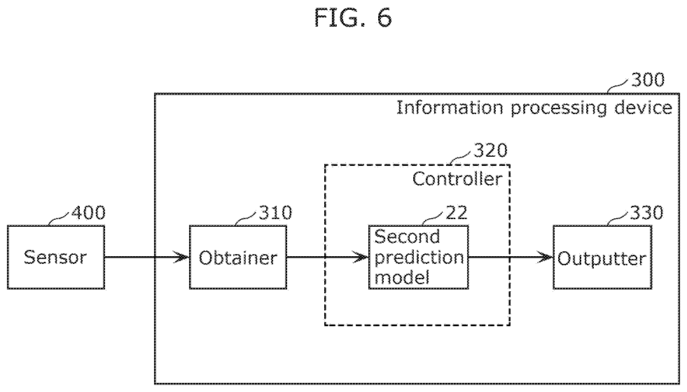

For example, second prediction model 22 after the training according to the embodiment explained above may be incorporated in a device. This is explained with reference to FIG. 6.

FIG. 6 is a block diagram illustrating an example of information processing device 300 according to another embodiment. Note that, in FIG. 6, sensor 400 is also illustrated other than information processing device 300.

As illustrated in FIG. 6, information processing device 300 includes obtainer 310 that obtains sensing data, controller 320 that inputs the sensing data to second prediction model 22 trained by the machine learning based on the first error and the second error and obtains a prediction result, and outputter 330 that outputs data based on the obtained prediction result. In this way, information processing device 300 including obtainer 310 that obtains sensing data from sensor 400, controller 320 that controls processing using second prediction model 22 after training, and outputter 330 that outputs the data based on the prediction result, which is an output of second prediction model 22, may be provided. Note that sensor 400 may be included in information processing device 300. Obtainer 310 may obtain sensing data from a memory in which the sensing data is recorded.

For example, the present disclosure can be implemented as a program for causing a processor to execute the steps included in the information processing method. In addition, the present disclosure can be implemented as a non-transitory, computer-readable recording medium, such as a CD-ROM, on which the program is recorded.

For example, when the present disclosure is implemented as a program (software), the respective steps can be executed by way of the program being executed using hardware resources such as a CPU, memory, and input/output circuit of a computer, etc. Specifically, the respective steps are executed by the CPU obtaining data from the memory or input/output circuit, etc., and performing arithmetic operations using the data, and outputting a result of the arithmetic operation to the memory or the input/output circuit, etc.

It should be noted that, in the foregoing embodiment, each of the structural components included in information processing system 1 is configured using dedicated hardware, but may be implemented by executing a software program suitable for the structural component. Each of the structural components may be implemented by means of a program executer, such as a CPU or a processor, reading and executing the software program recorded on a recording medium such as a hard disk or a semiconductor memory.

Some or all of the functions included in information processing system 1 according to the foregoing embodiment are implemented typically as a large-scale integration (LSI) which is an integrated circuit. They may take the form of individual chips, or one or more or all of them may be encapsulated into a single chip. Furthermore, the integrated circuit is not limited to an LSI, and thus may be implemented as a dedicated circuit or a general-purpose processor. Alternatively, a field programmable gate array (FPGA) that allows for programming after the manufacture of an LSI, or a reconfigurable processor that allows for reconfiguration of the connection and the setting of circuit cells inside an LSI may be employed.

In addition, the present disclosure also includes the various variations that can be obtained by modifications to respective embodiments of the present disclosure that can be conceived by those skilled in the art without departing from the essence of the present disclosure.

### INDUSTRIAL APPLICABILITY

The present disclosure can be applied to the development of a prediction model to be used during execution of deep learning on an edge device, for example.

1. An information processing method to be executed by a computer, the information processing method comprising:
obtaining first data;
calculating a first prediction result by inputting the first data into a first prediction model;
calculating a second prediction result by inputting the first data into a second prediction model;
calculating a degree of similarity between the first prediction result and the second prediction result;
determining second data which is training data for machine learning, based on the degree of similarity; and
training the second prediction model by machine learning using the second data, wherein
either:
the degree of similarity is whether or not the first prediction result and the second prediction result match, and
in the determining, when the first prediction result and the second prediction result do not match, data generated by processing the first data which has been inputted to the first prediction model and the second prediction model is determined as the second data;
or
the degree of similarity is a degree of similarity between a magnitude of a first prediction value in the first prediction result and a magnitude of a second prediction value in the second prediction result, and
in the determining, when a difference between the first prediction value and the second prediction value greater than or equal to a threshold value, the data generated by processing the first data which has been inputted to the first prediction model and the second prediction model is determined as the second data.

2. The information processing method according to claim 1, wherein
the first prediction model has a configuration different from a configuration of the second prediction model.

3. The information processing method according to claim 1, wherein
the first prediction model has a processing accuracy different from a processing accuracy of the second prediction model.

4. The information processing method according to claim 2, wherein
the second prediction model is obtained by making the first prediction model lighter.

5. The information processing method according to claim 3, wherein
the second prediction model is obtained by making the first prediction model lighter.

6. The information processing method according to claim 1, wherein
in the training, the second prediction model is trained using more of the second data than other training data.

7. The information processing method according to claim 1, wherein
the first prediction model and the second prediction model are neural network models.

8. An information processing system comprising:
an obtainer that obtains first data;
a prediction result calculator that calculates a first prediction result by inputting the first data into a first prediction model, and calculates a second prediction result by inputting the first data into a second prediction model;
a similarity calculator that calculates a degree of similarity between the first prediction result and the second prediction result;
a determiner that determines second data which is training data for machine learning, based on the degree of similarity; and
a trainer that trains the second prediction model by machine learning using the second data, wherein
either:
the degree of similarity is whether or not the first prediction result and the second prediction result match, and
in the determining, when the first prediction result and the second prediction result do not match, data generated by processing the first data which has been inputted to the first prediction model and the second prediction model is determined as the second data;
or
the degree of similarity is a degree of similarity between a magnitude of a first prediction value in the first prediction result and a magnitude of a second prediction value in the second prediction result, and
in the determining, when a difference between the first prediction value and the second prediction value greater than or equal to a threshold value, the data generated by processing the first data which has been inputted to the first prediction model and the second prediction model is determined as the second data.

9. An information processing device comprising:
an obtainer that obtains sensing data;
a controller that obtains a prediction result by inputting the sensing data into a second prediction model; and
an outputter that outputs data based on the prediction result obtained, wherein
the second prediction model is trained by machine learning using second data,
the second data is training data for machine learning and is determined based on a degree of similarity,
the degree of similarity is calculated from a first prediction result and a second prediction result,
the first prediction result is calculated by inputting first data into a first prediction model,
the second prediction result is calculated by inputting the first input data into the second prediction model, and
either:
the degree of similarity is whether or not the first prediction result and the second prediction result match, and
in the determining, when the first prediction result and the second prediction result do not match, data generated by processing the first data which has been inputted to the first prediction model and the second prediction model is determined as the second data;
or
the degree of similarity is a degree of similarity between a magnitude of a first prediction value in the first prediction result and a magnitude of a second prediction value in the second prediction result, and
in the determining, when a difference between the first prediction value and the second prediction value greater than or equal to a threshold value, the data generated by processing the first data which has been inputted to the first prediction model and the second prediction model is determined as the second data.
